(19) United States
(12) Patent Application Publication
(10) Pub. No.: US 2014/0337759 A1
(43) Pub. Date: Nov. 13, 2014

(54) Methods and Systems to Connect with Others

(71) Applicant: Samuel Bouter, Greenville, SC (US)

(72) Inventor: Samuel Bouter, Greenville, SC (US)

(21) Appl. No.: 13/889,354

(22) Filed: May 8, 2013

(51) Int. Cl. G06F 3/0484

(52) U.S. Cl. CPC G06F 3/0484
USPC 715/753

(57) ABSTRACT

A method and system to locate and/or create user events via a mapping application. The method and system include loading a software application onto a first user device, wherein the software application displays geographically related objects on a map. The first user may choose to join an event via the application. The system and method further includes a mechanism for said first user to negotiate event details with an event creator.

### BACKGROUND

Often users are located in an area in which they are unfamiliar and wish to locate others to connect or interact with. This may occur while the user is, for example, on business (sometimes for a long period of time) or if said user has recently moved to a new area. This situation may also occur in scenarios where a user is looking to find a new group of connections. Numerous other scenarios are apparent to one of ordinary skill in the art. Many prior art systems deal with connecting people you may already know (e.g. Facebook™). This type of connection is very narrow in scope and does not readily provide a platform for a user to meet others.

### SUMMARY OF THE INVENTION

In contrast, the current invention, in the primary embodiment is not solely directed toward establishing connections among other users who are already established as friends; but to allow user's who do not previously know one another to connect. Doing so enables a new plurality of different tools/algorithms that the prior art fails to provide.

The invention disclosed, in one embodiment, allows for users proximate to one another to connect one on one or in a group over a commonly agreed upon event type. The agreement on the event location, time, date and/or type may in one embodiment be pre-established by the event creator. In another embodiment, said variables may be negotiable.

A platform of the current system includes an application running on a non-transitory computer-readable memory of a device. In the primary embodiment, the application contains a map that includes numerous objects. An object in the context of the application may be a place-marker on the map that distinguishes a location of interest (e.g. an event or possible event as discussed below).

These embodiments and advantages of the invention will be set forth in part in the description which follows, and in part will be obvious from the description, or may be learned by practice of the invention. The advantages of the invention will be realized and attained by means of the elements and combinations particularly pointed out in the claims. Further it is to be understood that both the foregoing general description and the following detailed description are exemplary and explanatory only and are not limiting to the invention as claimed.

### BRIEF DESCRIPTION OF DRAWINGS

FIG. 1 discloses an exemplary software application being displayed on a computing device.

FIG. 2 discloses an exemplary embodiment of a user creating an event.

FIG. 3 discloses a flowchart of a user creating an undefined event.

FIG. 4 discloses an exemplary embodiment of the initialization process of the application on a user device.

FIG. 5 discloses an exemplary feature for a user to manually search for an event.

FIG. 6 discloses an exemplary interface that allows a user to join an event.

FIG. 7(A-D) discloses exemplary processes of a user joining an undefined event.

FIG. 8 discloses the integration of one exemplary means of advertising in the current invention.

### DETAILED DISCLOSURE

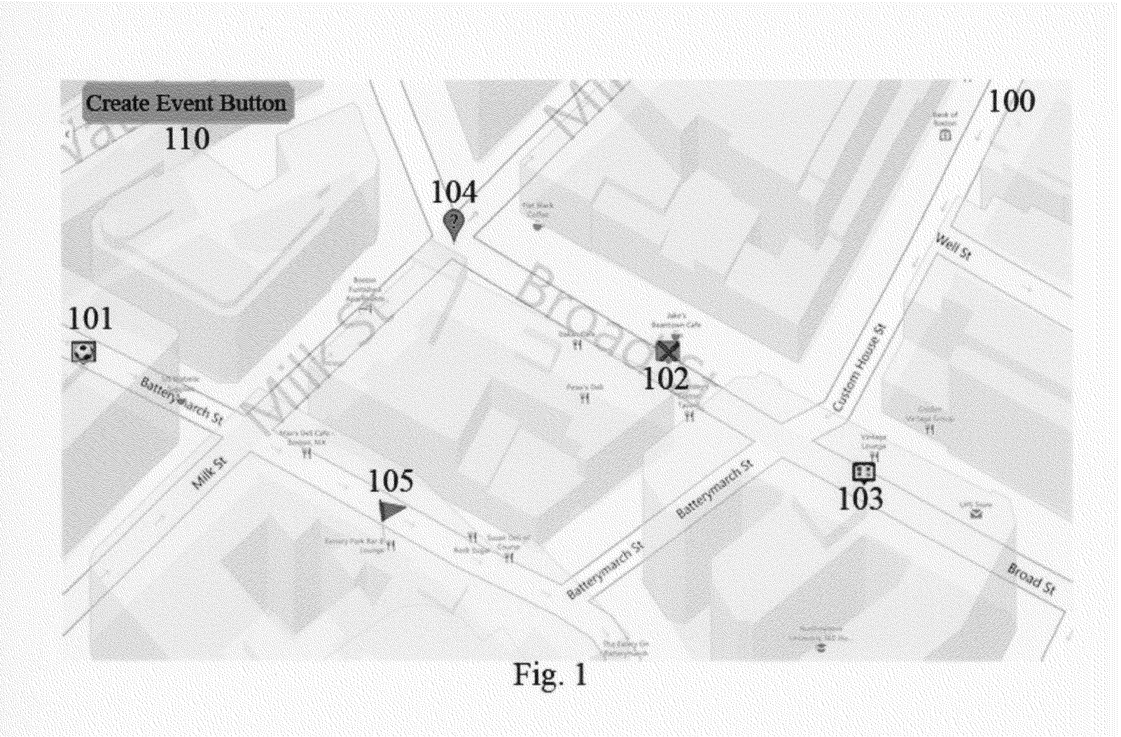

FIG. 1 discloses an exemplary software application 100 being displayed on a computing device. Numerous objects (e.g. pins, markers, etc.) may be placed on the map upon initialization of the application 100 on the computing device. Each object 101-104 represents a different type of object that was created by an event creator. Object 105 represents an object that was created by the platform (described in more detail below). Each object has associated with it at least: a general location (e.g. a city, zip or civic address) and a general date (e.g. date range).

For example, object 101 may be a sporting event that was created to indicate that an event creator is seeking six people to play basketball at 6:00 pm at the exact location indicated by the object 102. Object 102, may be a person wanting to meet a single individual for lunch at a particular time at the address indicated by the object 102. If there are multiple objects that overlap a predefined area (for example, 0.1 square miles), an object 103 may be placed at the center point of this area indicating that multiple events are occurring at this particular location. A user may then select said object and see a list of multiple objects (images, text, etc.) that are selectable to view additional event information.

Object 104 represents what is known as an “undefined event” (UE). A UE is an event that all variables are not defined for. For example, one or more of date, time, location and event type may not explicitly be stated by an event creator. A user who wishes to join this type of event would select this object to begin a negotiation process with the event creator (described in more detail below).

Object 105 represents what is known as an event creation object. An algorithm is used to determine if there are under a specific number of created objects (101-104) in a user's search area. If a user is searching, for example, in zip code 11111, and only two objects appear (that is, two of objects 101-104), the application 100 will generate a particular amount of suggested event creation pins. This allows a user to (instead of joining an already created event) create an event at the location of the object (described in more detail below).

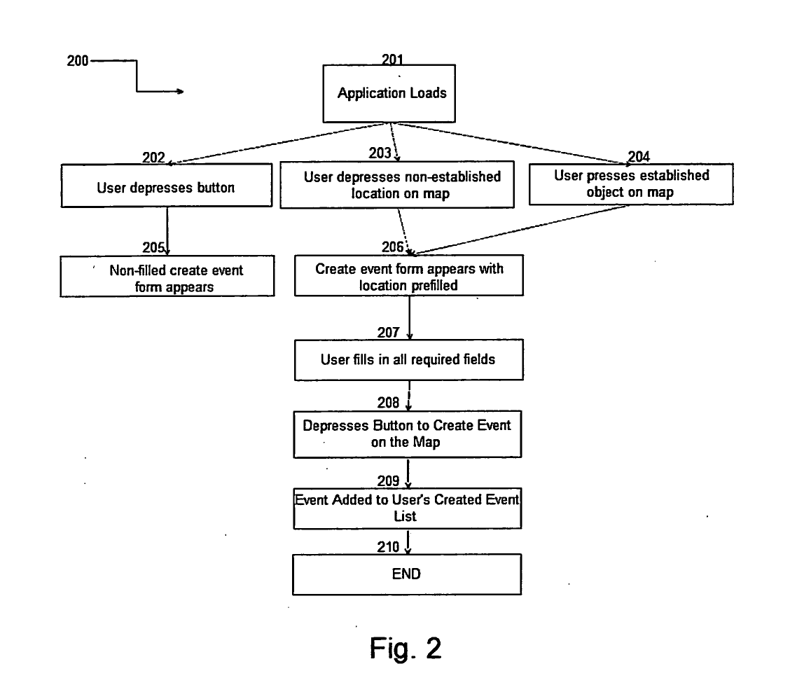

FIG. 2 discloses an exemplary embodiment 201 of a user creating an event. The method begins with step 201 whereby the application 100 is initialized. A user may create an event one of three ways. If a user depresses the create event button 110, the user is brought to an interface (step 205) that allows the user to enter detailed event information about the event they wish to create. Step 203 describes an alternative means to create an event whereby a user of application 100 may, for example select or press (e.g. long press with a finger, select with a pointer or any other suitable method) a non-established location on the map. In response, step 206 is carried out whereby the application 100 may open the “create event” interface and automatically insert the approximate location into the event location field. This allows an expedient method for a user to create an event without knowing (or having to look up) the establishment's specific location (e.g. civic address). Step 204 describes an alternative means to create an event whereby a user of application 100 may select or press an established object on the map. This established object may be object 105. In response, step 206 is carried out whereby the application 100 may open the “create event” interface and automatically insert the specific establishment location and/or name into the event location field and location name field respectively. In the create event interface, a user may indicate one or more of a specific location, a specific time (or specific time range), a specific date (or specific date range), event type, event capacity, event keywords, event description or any other descriptive variable that will enable those who are search for an event, to find said event. Further, a user has an option to select if the event is a closed event. For example, a user may wish for the event to be closed to a particular group of people. The groups may consist of one or more of a gender, an age, a hometown location, user rating (described below), past connections, or any other variable.

Step 207 continues by the user filling in at least all of the required event creation fields. In step 208, the user may depress a button or other object to officially create the event. Upon the exemplary depression of said button, the event object will appear if someone is searching in the general location of the event. Step 209 is then carried out whereby the event is added to a local database and/or a remote database. From this database, the user has an interface that pulls from said database. Said interface is used so that a user can manage all of the user's created events. In step 210, the current create event session ends. Note that in order to create an additional event, a user would begin on step 202, 203 or 204 (the program would not need to be re-initialized).

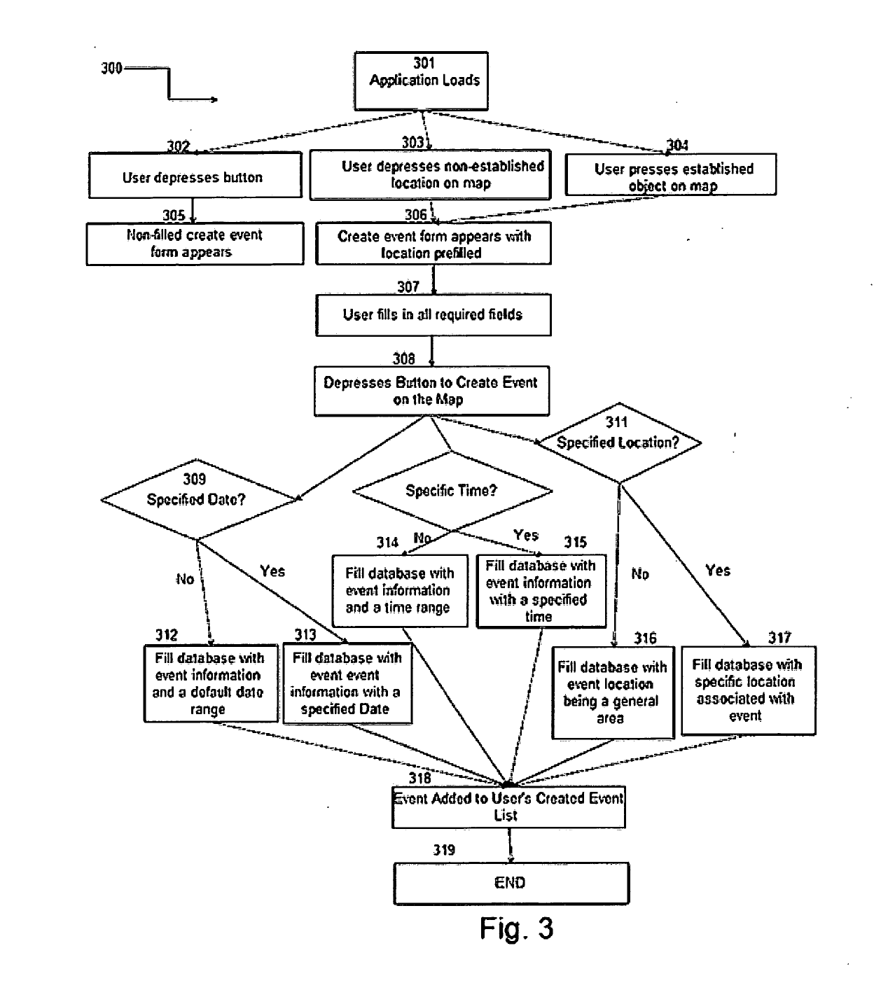

FIG. 3 discloses a flowchart of a user creating an undefined event. The process up until step 308 is, in the primary embodiment, mostly the same as FIG. 2. One of a plurality of possible differences would be that a different button or object would be pressed in order to indicate that the event being created is an “undefined event” (however, this is not necessary). Nonetheless, after the event creator fills in the required fields in step 307 and depresses the button in step 308, the application contains logic that ascertains whether the user has entered a specific date 309, time 310, and location 311 (note that event type is also a valid variable but has been left out of the figure for brevity). If the user does not enter a specific date, in one embodiment, a range of the current date to a user or platform defined end date is automatically entered into the database (step 312). If a specific time is entered 313, then the database is filled as described with relation to FIG. 2 above. If the user does not enter a specific time, in one embodiment, an undefined time value is automatically entered into the database (step 314) so that the event creator and user(s) wishing to join said event may negotiate a time (described in more detail below). If a specific time is entered (step 315), then the database is filled as described with relation to FIG. 2 above. If the user does not enter a specific location, in one embodiment, a general location is entered into the database (step 316) so that the event creator and user(s) wishing to join said event may negotiate a location (described in more detail below). If a specific location is entered (step 317), then the database is filled as described with relation to FIG. 2 above. In the preferred embodiment, a user must enter at least a general location parameter in the event creation interface. For example, a user must enter a city, zip code, civic address or any other general location that would allow the system to place the object (for example, object 104) onto a central location on the map for user consumption. The remaining steps are the same as in FIG. 2 above.

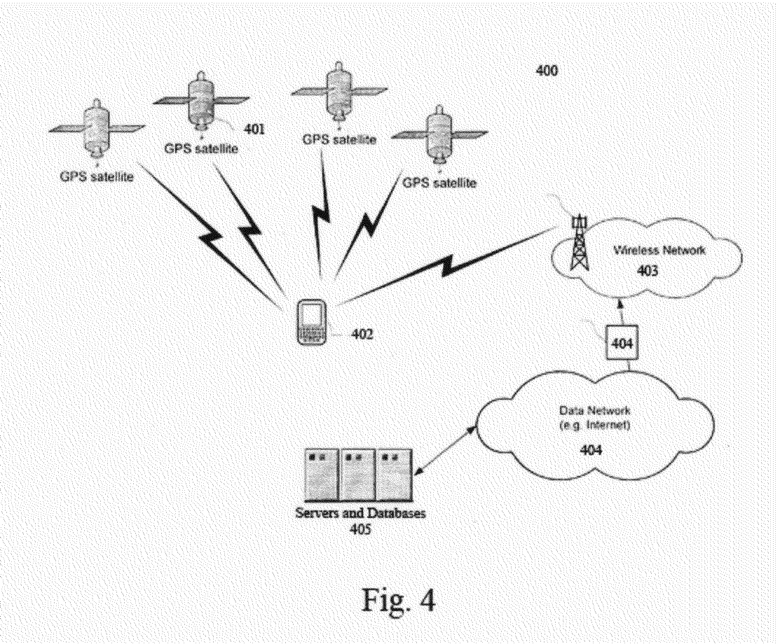

FIG. 4, discloses an exemplary embodiment of the initialization process of application 100 on a user device. The user has many options to control how the application displays upon startup. In one embodiment, during initialization of Application 100, instructions are provided that automatically locate the users current location using Global Positioning Systems (GPS) based technology, cellular triangulation methods, or any other mechanism to locate the approximate location of the computing device. Upon location detection, the user is shown a map displaying (preferably centered on) said users location. The map may then display a plurality of objects as seen in FIG. 1 above. In FIG. 4, a module in device 402 communicates with GPS satellites 401 to locate the device's current position. Once the device's current position is ascertained, application 100 may bring up relevant location information for the user of the device 402.

In another embodiment, the user may wish to always have a particular location display upon startup of the application 100. For example, if a user has entered in their application profile that zip code “12345” should always appear upon application 100 initialization, then the application shows objects for the area containing said zip code.

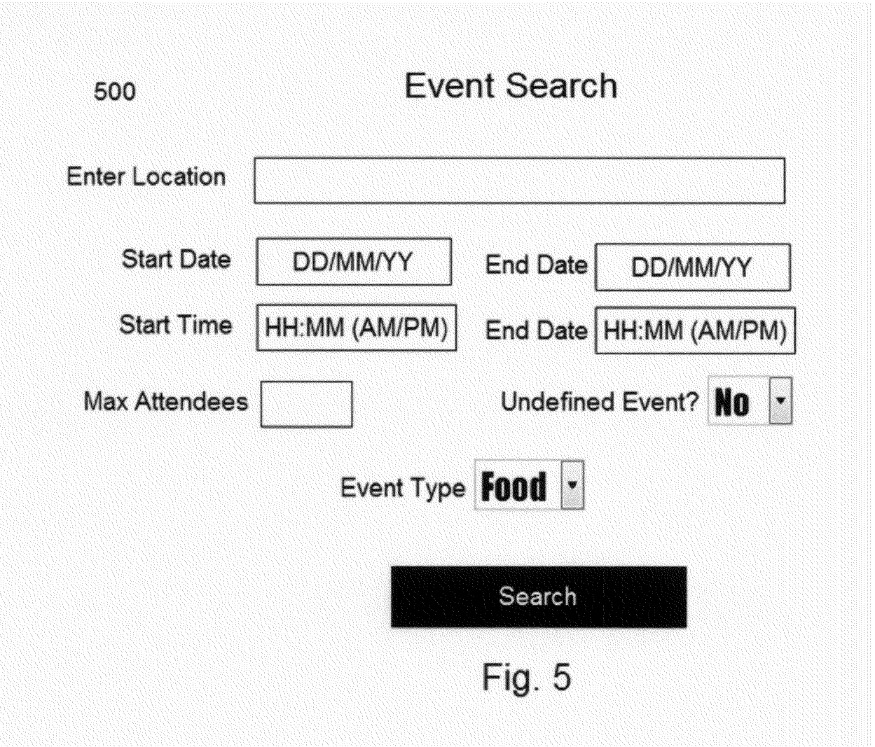

In another embodiment, the user may wish for nothing to happen during initialization until the user manually searches for an area (described in FIG. 5 below), or for the user to manually press an object that then locates the user (e.g. a “locate me” button).

The invention may use one or more wireless networks 403 to communicate to servers and databases 405 via a data network 404. The type of database used may be any currently known and/or future database technology as long as it is capable of handling the functions performed by the application platform described.

FIG. 5 discloses an exemplary interface 500 for a user to manually search for an event. A user may search for an event by one or more of a location, start time, end time, start date, end date, event type, event capacity, event keywords (e.g. sushi or basketball), undefined events and more (note that most of the search criteria has been omitted from FIG. 5 for brevity). Other variables may include the event creator's interests, age, gender, specific user, specific establishment, or any other variable that allows a user to specifically locate events of interest. A further option may even be presented that allows a user to only view (or exclude) events created by users that said user has joined in the past.

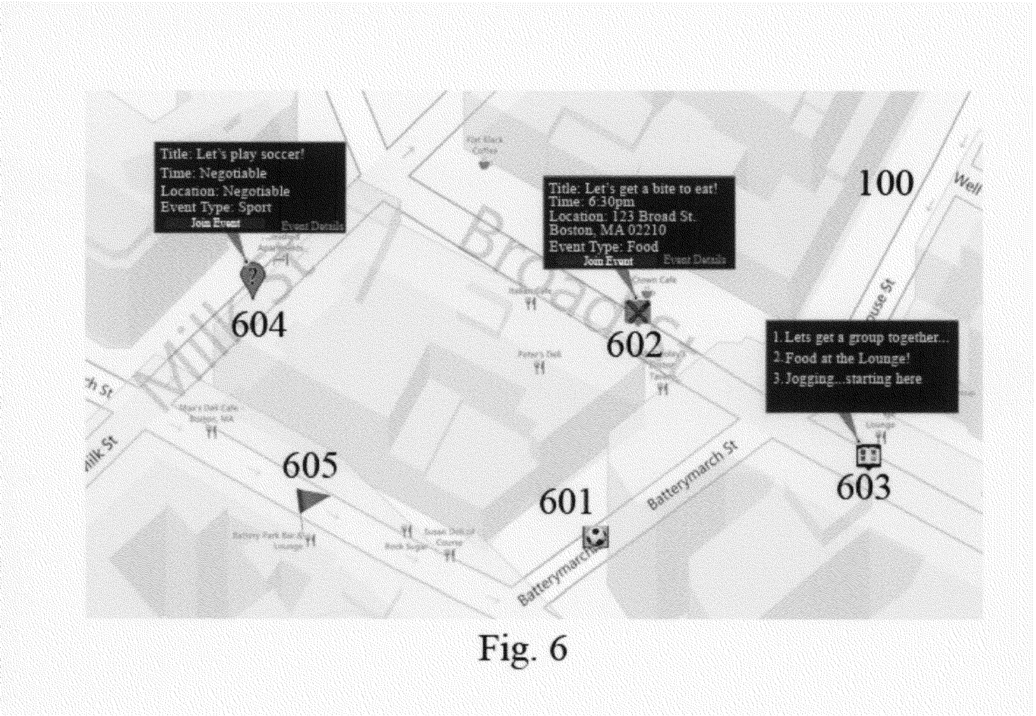

FIG. 6 discloses an exemplary interface that allows a user to join an event after objects on said map are displayed via the initialization process described in FIG. 4 or the search process disclosed in FIG. 5. A user may in one embodiment, scroll over or click an object on the map to view the expanded view of the event (event details) and to join said event. The expanded view may present in the form of a pop-over (602-604), a pop-up (not shown), a new page (not shown), or any other means to display to the additional information to the user. In the exemplary example of a pop-over shown in FIG. 6, a user may view one of said pop-overs by placing their cursor over an object. In FIG. 6, the pop-overs may contain any amount of information that provides information about the event. The pop-over may even contain the full event details.

If a user decides to join an event, said user may, for example, depresses a “Join Event” button associated with the pop-over. The multiple event icon pop-over may take on many forms. In one embodiment a user may have to “mouseover” or click on each item to gain additional information and/or to join said event. Upon mouseover or click of said individual event, an additional pop-over next to the first pop-over 603 may contain the event information; much like the pop-overs of 602 and 603.

The “event details” page contains the full details of the event. One may view information about the poster via a link to said posters profile, an event description, time, date, capacity, an event location review, location rating, or any other relevant variable. Finally, a user may join an event by, for example, clicking on a “Request to Join” action object (e.g. a button, link, etc.).

The user may have an event status interface where said user can view all of the event join requests and their respective statuses (pending/accepted/rejected).

Upon a user requesting to join said event, the event creator may be sent a message indicating that said user has requested to join the created event. The event creator may in response, view said user's profile information (FIG. 10 below) and either accept, deny or ignore said event request.
a. If the event creator rejects said join request, said creator may input a personal message along with said rejection to indicate why the join request has been rejected. Said user may be sent said rejection along with said message. Alternatively, the system may merely treat the rejection in the same manner as the “ignore” option (explained below in c). In one embodiment, the system will indicate to the requesting user that the event has been canceled in order to mitigate any problems stemming from being rejected.
b. If the event creator accepts said join request, the user is provided a message indicating that the event creator has accepted said request. Further, the event status interface would be updated to show that the request is no longer pending, but accepted.
c. If the event creator ignores said join request (i.e. does not accept or reject), the event status interface for the particular event will always be pending until the conclusion of the event has occurred. Upon conclusion of the event, the event will be removed from the event status interface entirely. In another embodiment, the system will indicate to the requesting user that the event has been canceled (said user will not be able to view said event) in order to mitigate any problems stemming from being ignored; although the event is still active.

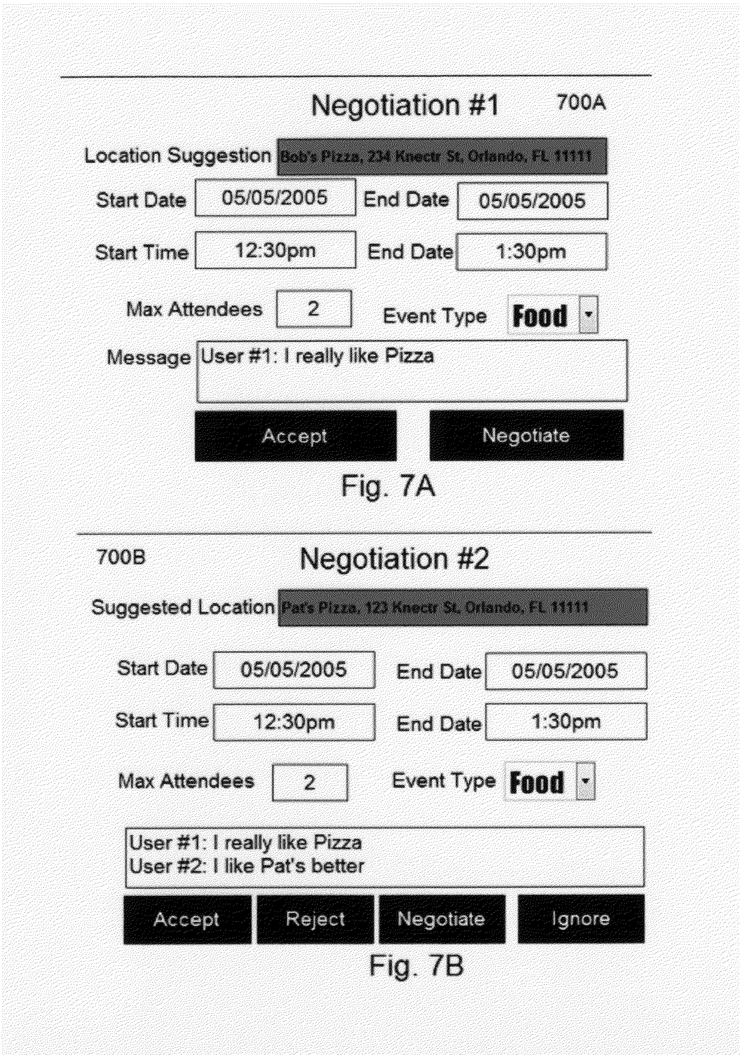

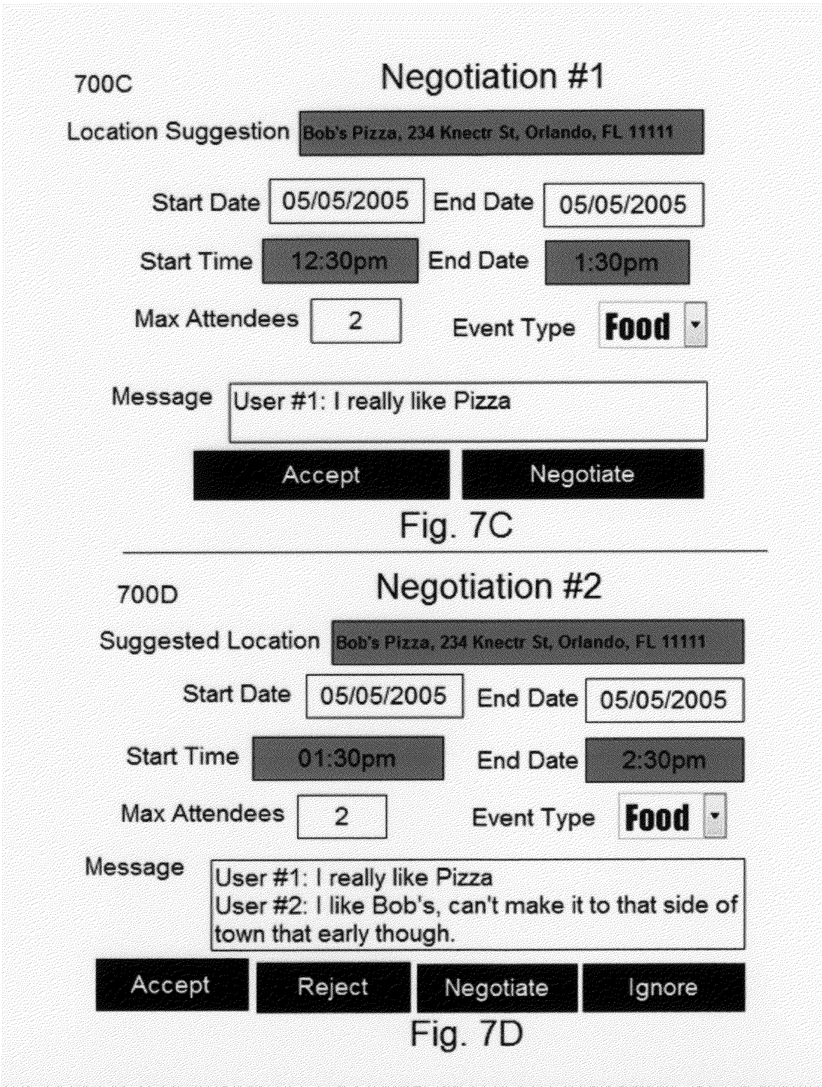

FIG. 7 discloses an exemplary process of a user joining an undefined event from the interface following the user being presented with event objects (discussed in FIG. 4). An undefined event is an event that does not have a specifically defined location and/or date/time and/or event type. A specific time would be, for example, 4:00 pm EST; a specific location would be, for example, 600 Dulany St. Alexandria, Va. 22314; a specific event type would, for example, food. A completely undefined event may have an undefined starting time (i.e. anytime from 12:00 am-11:59 pm), a date of 03/01/2013-03/15/2013 (depending the default date range of an undefined date), anywhere in Alexandria, Va., with no event type specified. Note that for an unspecified date, the system may take the current date as the starting date and make a system or user defined end date (e.g. 15 days).

Upon joining an undefined event, the user may enter into a negotiation process with the event creator in order to define some or all of the undefined variables mentioned above. FIG. 7A shows an exemplary negotiation interface that will enable the joining user to input a suggestion for a location. The blue box indicates that the box is editable and ready to accept a suggestion by the joining user. Upon the event creator receiving the suggestion (FIG. 7B), said event creator may either accept said suggestion in full, make modifications to some or all of the variables, reject the event request or ignore the event request (FIG. 6 procedure above). Note that a blue box is merely used as an example to distinguish between an undefined field and a defined field. Any means of distinguishing said fields may be used and would not stray from the scope of the instant invention.

If the event creator accepts the suggestion in full, the event is processed as a normal event creation with a specific time, specific date and specific location. If the event creator wishes to change some or all the variables, the event creator may, via an event suggestion modification interface, change one of the variables and send the request back to the user. In FIG. 7B, the event creator has received a location suggestion for “Bob's Pizza” from a joining user. The event creator may not like Bob's Pizza, but seeing that user #1 enjoys pizza, has stuck with the theme and approximate location by renegotiating for a different pizza place on the same street.

This negotiation process may continue back and forth between the user and the event creator until a specified time, date and location is ascertained by both parties. As one of ordinary skill in the art knows, there may be numerous combinations of any type of negotiation variable. For example, a negotiation variable may even include what type of sport (e.g. soccer, basketball, jogging). Upon accepting an event, the event may be added to a user's calendar that may be part of or external to the platform. For example, a user may connect a 3^{rd} party calendar (e.g. Microsoft® Outlook®, or Google Calendar™, etc.) to the platform so that the event is added to the user's calendar.

In one embodiment, until the event creator has accepted a negotiation from an event joiner, any number of people may request to join the event and enter into negotiations with the event creator; regardless of event occupancy. However, when the event creator accepts an event negotiation with a particular user, negotiations with all other users may cease. The event creator must then either request other users (if any) to join the negotiated event, or accept other users request to join the negotiated event. In other embodiments, once an event creator has entered into negotiations with a number of joining users that equals the current occupancy of the event, no other people may enter into negotiations with said event creator until a joining user drops out of negotiations. A joining user may drop out of negotiations at any time by, for example, by depressing a “leave negotiations” object (not shown). In another embodiment, only one user may negotiate with the event creator at a time.

FIGS. 7C and 7D disclose another example where two variables are undefined. As discussed above, any variable that affects user's connecting may be negotiated.

It is noted that under another embodiment, if a user who joins an event does not wish to negotiate, said user may simply join the event and select an option to accept whatever the group concludes. That is, in an event with an occupancy of three (event creator and two event joiners), a first of the user's joining the event can be completely passive while the second joining user and the event host negotiate. In this manner, someone can join an undefined event and not actually participate in negotiations.

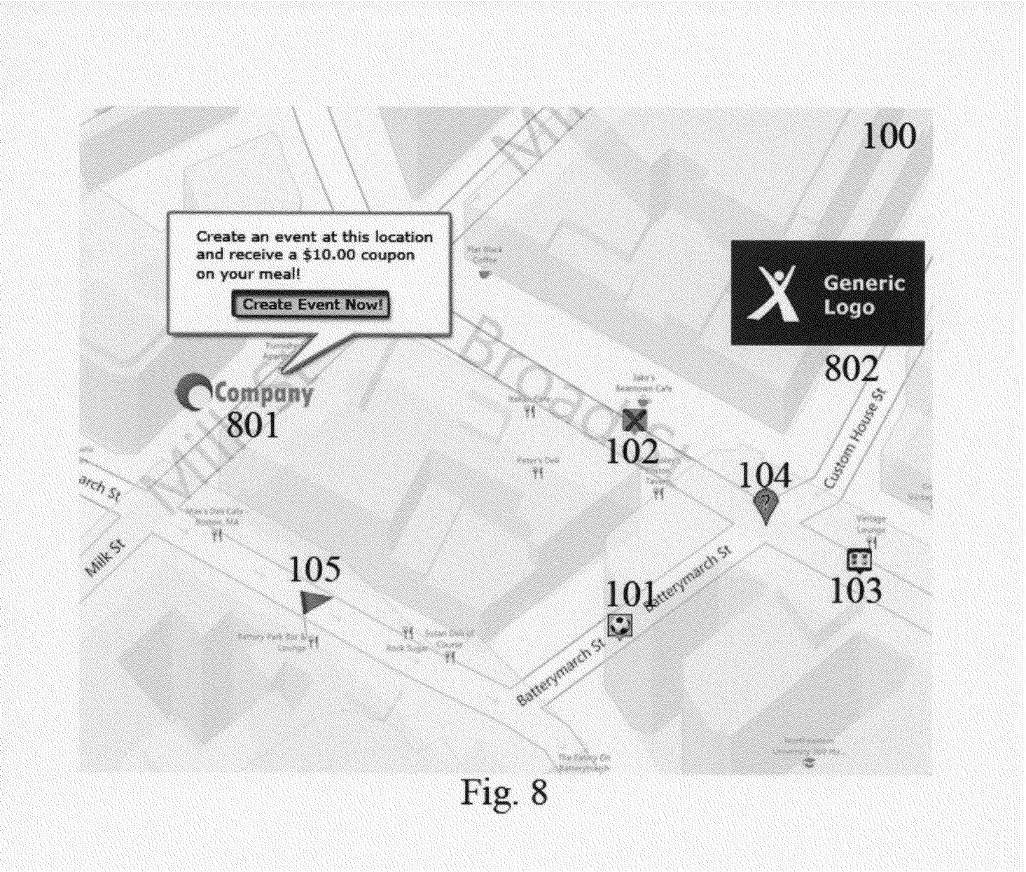

FIG. 8 discloses the integration of one exemplary means of advertising in the current invention. In FIG. 8, a place of interest (e.g. a fictitious establishment 801) may wish for their logo to stand out when a user is choosing to create an event in a particular area. For example, if a user wishes to create an event somewhere in Houston, Tex., the initial map page may show a plurality of objects, wherein one or more may be an establishment logo. Upon clicking, users may be taken to the interface where they can create an event at that particular establishment. In some embodiments, users may be provided coupons or other types of discounts for choosing to host their event at a particular establishment. In other embodiments, the coupons are provided by merely selecting the logo or other advertisement while joining or viewing an already created event.

In one embodiment, If an establishment wishes to place their, for example, logo on a map area, they may purchase said placement. The cost of logo placement may be determined by one or more of: the size of the logo, the color of the logo, the area on the map, the length of time said logo is to remain on the map, view count of the logo, click count of the logo, or any other variable relating to economical competition among other establishments. For example, if a business wishes to place their logo where many other logos currently reside, the price may be higher. Another example is if an establishment wishes for their logo to stand out by being very large in size; this may cost more then a smaller sized logo.

In another embodiment, users who are joining an event may be shown an event that is being hosted at an establishment who is a “preferred partner” of the platform. A preferred partner is one who has a working relationship with the platform. Said relationship could be any kind of business or personal relationship (e.g. a monetary relationship). Joining a “preferred partner” related event may have incentives for a user (e.g. coupons, promotions, etc.).

In another embodiment, the platform may be used to connect people of interest to an interested audience. For example, assume that the president of a major company in town is holding a lunch at a particular restaurant for charity. Said president may use a charitable interface in application 100 to obtain attendees for the lunch. Users may join said lunch by paying a charitable donation via a payment interface in application 100 (directly or indirectly).

In another embodiment, certain events may require payment to join. Payment may be made on a payment interface associated with the platform.

User Profile

Each user of the system may have a profile. A user may enter numerous pieces of information into their profile; some mandatory upon registration or prior to performing certain actions on the platform, and others optional. For example, upon registration, an e-mail address and password may be required. Further information that may be contained in a user profile are a username, user's name, location, interests, profession, pictures/photos, video, user reviews, or any other known to one of ordinary skill in the art social networking profile variables.

A user profile may contain reviews made by other users (described below) in the form of one or more textual and/or media based feedback. A “star” rating (e.g. 1-5 stars) may be used in order to visually rate a user.

User Verification

In one embodiment, a mechanism to verify users of the current system is disclosed. One problem that may arise stems from the fact that people will be interacting with others whom they (most likely) have never met and know little to nothing about. To circumvent this possible issue, security mechanisms should be established.

In one embodiment, after using the service (two or more people have attended an event with one another), users and event creators have the option to leave feedback providing a negative, neutral or positive account of the other user(s) they have met. In this way if, for example, a user has had numerous positive connections with other users, people will feel more comfortable making a connection via event establishment with this particular user (and vice versa). In another embodiment, a credit card verification system may be used. In another embodiment, a criminal background check may be used. Other systems may be used, in isolation or in combination to the above in order to personally vouch for a particular member of the system. The reviews may appear in association with the user's profile.

Presence Notifications

A mechanism may be used to aid event attendees (including the host) in knowing when other attendees have arrived at the event. In one embodiment, the use of tracking mechanisms (e.g. triangulation and/or GPS) techniques can be used to indicate that a particular attendee has arrived, is close, or is on route. In another embodiment, an attendee who has arrived at the event may provide an indication via the platform. The application 100 will also indicate to any of the attendees if another attendee has made a formal cancellation via the application 100.

Further, the application 100 may link to and integrate with other social networking sites in order to enhance the user experience.

It is noted that the present invention may use other means to receive input from a user such as motion detection and voice recognition technologies.

It is noted that the present invention may be used in conjunction with any type of computer known in the art. For example, the device may be, for example, a mobile phone, a laptop computer, a desktop computer, a tablet device or any other computing device known in the present or future.

A “machine-readable medium” or “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented in whole or in part by using a programmed general purpose digital computer; by using application specific integrated circuits, programmable logic devices, field programmable gate arrays, optical, chemical, biological, quantum or nanoengineered systems or mechanisms; and so on. In general, the functions of the present invention can be achieved by any means as is known in the art. Distributed or networked systems, components, and/or circuits can be used. Communication, or transfer of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above. Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”, “an”, and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A non-transitory computer-readable medium contained in a device, said non-transitory computer-readable medium containing software that is executed by a processor, said software programmed to generate the following for a user of the software:
a map displayed on a screen of said non-transitory computer-readable medium;
a population module wherein upon initialization of said software, objects are populated on said map, said objects each representing two or more categories of an event type;
a display selection module allowing a joining user to select said objects contained on said map thereby allowing said user to join an event;
a negotiation module allowing a joining user to recommend one or more parameters of a created event wherein said parameters are one or more of a time, specific location and event type for an event when an already created event created by an event creator is displayed on said map and does not contain one or more of a specific time, specific location, or specific event type;
the negotiation module, upon receiving said negotiation, allows the event creator to accept or reject said negotiation using said negotiation module.

2. The non-transitory computer-readable medium of claim 1, wherein: the population module detects if an already created event object is associated with a specific time, and if so, inserting the time into an information box associated with the object on the map, and if said event does not include an associated time, the recommendation module creating an interface for a user to enter a suggested time.

3. The non-transitory computer-readable medium of claim 1, wherein: the population module detects if an already created event object is associated with a specific location, and if so, inserting the object onto the specific location on the map, and if said event does not include a specific location, the recommendation module creating an interface for a user to enter a specific location.

4. The non-transitory computer-readable medium of claim 1, wherein: the population module detects if an already created event object is associated with a specific location and a time, and if so, inserting the object onto the specific location on the map and inserting the time into an information box associated with the object on the map, and if said event does not include a specific location and a specific time, the recommendation module creating an interface for a user to enter a specific location and a time as a recommendation to the event creator.

5. The non-transitory computer-readable medium of claim 1, wherein: the population module, upon initialization, calculates a number of objects associated with a location of interest, and if the number of user created objects is below a threshold, populating additional objects on the map, wherein the number of additional objects is based on an algorithm.

6. The non-transitory computer-readable medium of claim 5, wherein: the population module detects a location of interest by one of: a user's current physical location, a predefined setting in a user profile, a current user location selection after map initialization, and the last known position of the user.

7. The non-transitory computer-readable medium of claim 1, wherein: the population module detects whether a proximity of multiple created event objects is below a threshold, if said proximity value is below said threshold grouping said multiple objects into a single object.

8. The non-transitory computer-readable medium of claim 1, wherein: said specific location is defined as any combination of one or more of a: civic address, specific longitude along with a specific latitude, and establishment name in combination with an area.

9. The non-transitory computer-readable medium of claim 1, wherein: the software provides a further option allowing the event creator to re-negotiate a specific time, specific location and/or specific event type if said event creator rejects the first negotiation.

10. A method of providing software to a user, said software running on a device that comprises a non-transitory computer-readable medium, and when executed the software:
displays a map on a screen, of the device, wherein upon initialization of said software, objects are populated on said map, said objects each representing two or more categories of an event type;
allowing a joining user to select said objects contained on said map thereby allowing said user to join an event;
allowing a joining user to recommend one or more parameters of a created event wherein said parameters are one or more of a time, specific location and event type for an event when an already created event created by an event creator is displayed on said map and does not contain one or more of a specific time, specific location, or specific event type;
wherein upon receiving said recommendation, the event creator may accept or reject said recommendation using said recommendation module.

11. The method of claim 1, further comprising: detecting if an already created event object is associated with a specific time, and if so, inserting the time into an information box associated with the object on the map, and if said event does not include an associated time, the recommendation module creating an interface for a user to enter a suggested time.

12. The method of claim 1, further comprising: detecting if an already created event object is associated with a specific location, and if so, inserting the object onto the specific location on the map, and if said event does not include a specific location, displaying an interface for a user to enter a suggestion for a specific location.

13. The method of claim 1, further comprising: detecting if an already created event object is associated with a specific location and a time, and if so, inserting the object onto the specific location on the map and inserting the time into an information box associated with the object on the map, and if said event does not include a specific location and a specific time, creating an interface for a user to enter a specific location and a time as a recommendation to the event creator.

14. The method of claim 1, further comprising: upon initialization, calculates a number of objects associated with a location of interest, and if the number of user created objects is below a threshold, populating additional objects on the map, wherein the number of additional objects is based on an algorithm.

15. The method of claim 13, further comprising detecting a location of interest by one of: a user's current physical location, a predefined setting in a user profile, a current user location selection after map initialization, and the last known position of the user.

16. The method of claim 1, wherein: detecting whether a proximity of multiple created event objects is below a threshold, if said proximity value is below said threshold, grouping said multiple objects into a single object

17. The method of claim 1, wherein: said specific location is defined as any combination of one or more of a: civic address, specific longitude along with a specific latitude, and establishment name in combination with an area.

18. The method of claim 1, further comprising: the software provides a further option allowing the event creator to re-negotiate a specific time, specific location and/or specific event type if said event creator rejects the first negotiation.
